(19) United States
(12) Patent Application Publication
(10) Pub. No.: US 2008/0059627 A1
(43) Pub. Date: Mar. 6, 2008

(54) UNIFIED CONTACT DATABASE

(76) Inventors: Jari P. Hamalainen, Kangasala AS (FI); Heikki Heinaro, Helsinki (FI); Tero Immonen, Helsinki (FI); Ilpo Karjalainen, Oulu (FI); Atte Lahtiranta, Mountain View, CA (US)

Correspondence Address: PERMAN & GREEN, 425 POST ROAD, FAIRFIELD, CT, 06824, US

(21) Appl. No.: 11/468,163

(22) Filed: Aug. 29, 2006

(51) Int. Cl. G06F 15/173; G06F 15/16; G06F 17/30; G06F 3/048

(52) U.S. Cl. 709/224; 707/104.1; 709/227; 715/764

(57) ABSTRACT

An apparatus having a controller configured to store, in a memory, a set of contact names, each contact name being associated with one or more account identifiers that identifies a communication protocol for communicating with the contact. The controller is further configured to establish a communication connection to a selected contact via a communication protocol associated with a selected account identifier.

### CROSS-REFERENCE TO RELATED APPLICATIONS

This application is related to the following U.S. Patent Applications: “VOICE MAIL EXTENSION”, Attorney Docket Number 684-012587-US (PAR); “REPLYING THROUGH DIFFERENT CHANNELS”, Attorney Docket Number 684-012588-US (PAR); “ACTIVE IDLE EXTENSION”, Attorney Docket Number 684-012589; and “MOBILE COMMUNICATION DEVICE”, Attorney Docket Number 684-012590-US (PAR), all of which were filed on Aug. 29, 2006, the disclosures of which are incorporated herein by reference in their entirety.

### BACKGROUND

1. Field

The disclosed embodiments relate to communication devices and, more specifically, to unifying multiple service providers and communication protocols in a single device.

2. Brief Description of Related Developments

Communication devices such as mobile phones may be operable to communicate with remote parties using different protocols, formats, or service providers. This may include, for example, cellular telephone calls, VoIP telephone calls, email, instant messaging, SMS and MMS. Each protocol or format can require a unique username. For each protocol, format, or service provider the device may maintain a separate contacts list, based on the unique requirements for that protocol or service provider. For example, the device may have one list of contacts or usernames for communicating by telephone call and another list of contacts or usernames for communicating by instant messaging. To reach a party via a telephone call may require selecting the appropriate name from a telephone contacts list, while reaching the same party via instant messaging may require selecting from a separate instant messaging contacts or usernames list. Therefore, initiating a communication with a remote party may require the user to manually search through each of the lists for each of the protocols, formats, or service providers, i.e. the unique user name. Furthermore, some communications formats such as instant messaging may have protocols for providing presence data. The presence data may indicate, for example, whether the party is immediately reachable through a particular instant messaging account, or whether or not the party wishes to be disturbed. It may be useful for the user to know the presence data for a party provided through one format, even though it is possible to contact the party through another format. For example, if the instant messaging presence for the remote party's account is programmed to reflect a condition generally understood as “do not disturb”, the user may decide not to telephone that party, since that party may generally be unreachable at that time.

It can be cumbersome and time consuming to search through one or more contact's list for a user name associated with a specific provider or protocol, particularly when such lists may be particular to a particular service. Therefore, there is a need to provide a unified contacts list for contacting a party through different protocols, formats, or service providers, and there is a need to provide for the integration of available presence data into such a list.

### SUMMARY

In a first aspect, the embodiments of the invention are directed to an apparatus. In one embodiment, an apparatus comprises a controller, a memory connected to the controller, a user interface connected to the controller, and a communication module connected to the controller. The controller is configured to store, in the memory, a set of contact names, each contact name being associated with one or more account identifiers that identifies a communication protocol for communicating with the contact. The controller is further configured to establish a communication connection to a selected contact via a communication protocol associated with a selected account identifier.

In one aspect, the disclosed embodiments are directed to a method comprising storing, in a memory of a communications device, at least a list of contact names and a set of account identifiers for each name. The method further comprises monitoring a presence for a contact name for each of the more than one account identifiers on a communications network.

In another aspect, the disclosed embodiments are directed to a computer program product. In one embodiment, the computer program product comprises a computer useable medium having computer readable code means embodied therein for causing a computer to maintain a list of contact names in a computer memory, at least one of the contact names being associated, in the memory, with more than one account identifier.

### BRIEF DESCRIPTION OF THE DRAWINGS

The foregoing aspects and other features of the disclosed embodiments are explained in the following description, taken in connection with the accompanying drawings, wherein:

FIG. 1 shows a schematic illustration of a cellular telecommunication system, as an example in which aspects of the invention recited in the claims may be applied.

FIG. 2A shows a device incorporating aspects of the invention recited in the claims;

FIG. 2B shows another device incorporating aspects of the invention;

FIG. 3 is a schematic diagram illustrating one embodiment of the device of FIG. 2A;

FIG. 4 is a schematic diagram illustrating another embodiment of the device of FIG. 2A;

FIG. 5 is a schematic diagram illustrating another embodiment of the device of FIG. 2A;

FIG. 6 is a schematic diagram illustrating another embodiment of the device of FIG. 2A;

FIG. 7 a schematic diagram illustrating another embodiment of the device of FIG. 2A;

FIG. 8 is a block diagram of one embodiment of an architecture that can be used to practice aspects of the invention.

### DETAILED DESCRIPTION OF THE EMBODIMENT(s)

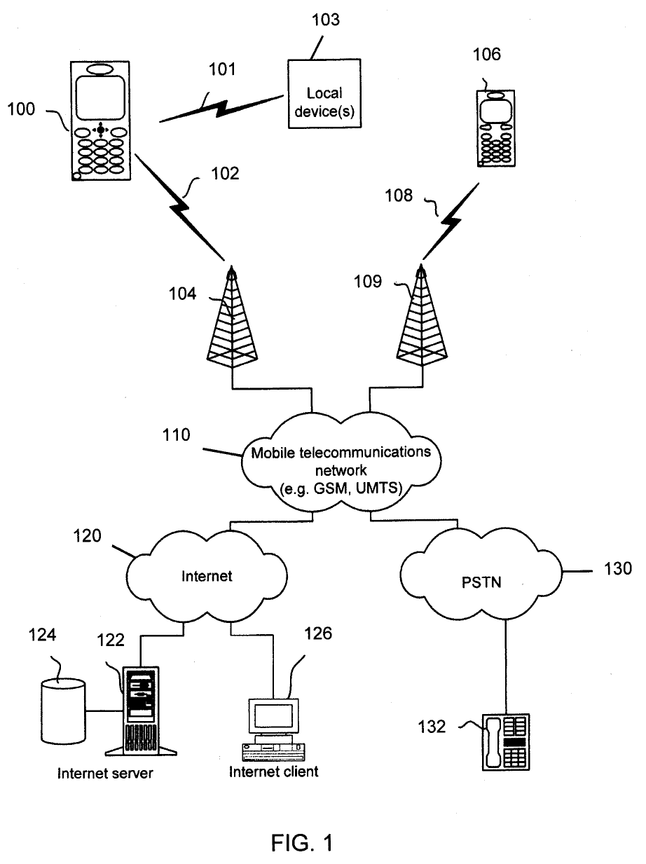

FIG. 1 illustrates a schematic illustration of a cellular telecommunications system, as an example, of an environment in which a communications device 100 incorporating features of the disclosed embodiments may be applied. Although aspects of the invention will be described with reference to the embodiments shown in the drawings and described below, it should be understood that these aspects could be embodied in many alternate forms of embodiments. In addition, any suitable size, shape or type of elements or materials could be used.

In the telecommunication system of FIG. 1, various telecommunications services such as cellular voice calls, www/wap browsing, cellular video calls, data calls, facsimile transmissions, music transmissions, still image transmission, video transmissions, electronic message transmissions, electronic commerce and the like may be performed between the mobile terminal 100 and other devices, such as another mobile terminal 106, a stationary telephone 132, or an internet server 122. It is to be noted that for different embodiments of the mobile terminal 100 and in different situations, different ones of the telecommunications services referred to above may or may not be available. The aspects of the invention are not limited to any particular set of services in this respect.

The mobile terminals 100, 106 may be connected to a mobile telecommunications network 110 through, for example, radio frequency (RF) links 102, 108 via base stations 104, 109. In alternate embodiment, the mobile terminals can be connected or coupled with the mobile telecommunications network through any suitable links. The mobile telecommunications network 110 may be in compliance with any commercially available mobile telecommunications standards such as for example, GSM, UMTS, D-AMPS, CDMA2000, FOMA and TD-SCDMA.

The mobile telecommunications network 110 may be operatively connected to a wide area network 120, which may be the internet or a part thereof. An internet server 122 has data storage 124 and is connected to the wide area network 120, as is an internet client computer 126. The server 122 may host a www/wap server capable of serving www/wap content to the mobile terminal 100.

For example, a public switched telephone network (PSTN) 130 may be connected to the mobile telecommunications network 110 in a familiar manner. Various telephone terminals, including the stationary telephone 132, may be connected to the PSTN 130.

The mobile terminal 100 is also capable of communicating locally via a local link 101 to one or more local devices 103. The local link may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 103 can include, for example, various sensors that can communicate information to the mobile terminal 100 over the local link 101. The above examples are not intended to be limiting, and any suitable type of link may be utilized. The local devices 103 may also include antennas and supporting equipment forming a WLAN implementing Worldwide Interoperability for Microwave Access (WiMAX, IEEE 802.16), WiFi (IEEE 802.11x), or other communication protocols. The WLAN may be connected to the internet. The mobile terminal 100 may thus have multiradio capability for connecting wirelessly using mobile communications network 110, WLAN, or both. Communication with the mobile telecommunications network 110 may also be implemented using WiFi, WiMAX, or any other suitable protocols, and such communication may utilize unlicensed portions of the radio spectrum (e.g. Unlicensed Mobile Access (UMA)).

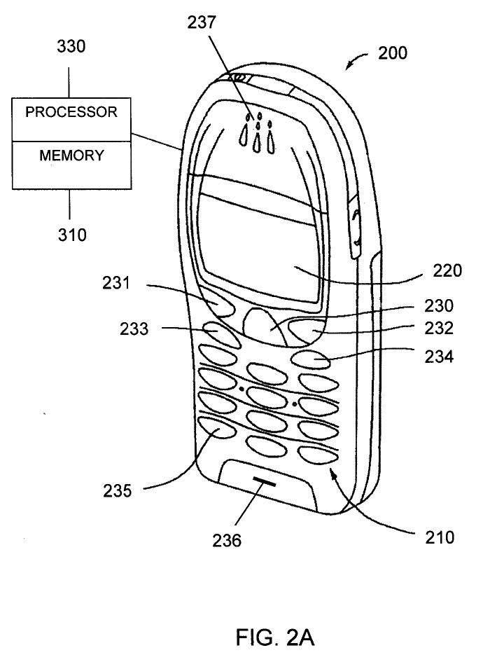

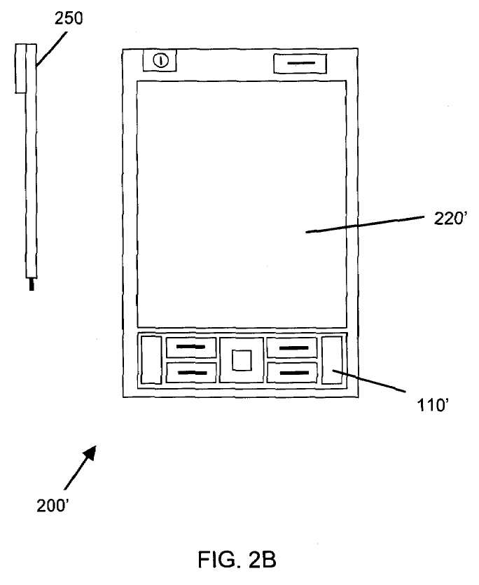

One embodiment 200 of a terminal 100 is illustrated in more detail in FIG. 2A. The mobile communications device or terminal 200 of FIG. 2A may have a keypad 210 and a display 220. The keypad 210 may include any suitable user input devices, such as for example, a multi-function/scroll key 230, soft keys 231, 232, a call key 233 and end call key 234 and alphanumeric keys 235. The display 220 may be any suitable display, such as for example, a touch-screen display or a graphical user interface. The display may be integral to the device 200 or the display may be a peripheral display connected to the device 200. A pointing device, such as for example, a stylus, pen or simply the user's finger may be used with the display 220. In alternate embodiments any suitable pointing device may be used. In other alternate embodiments, the display may be a conventional display. The device 200 may further include a speaker 237 and microphone 236 for use in communications such as, for example telephone conversations, and a processor 330 and memory 310 for implementing aspects of the invention as will be described below. The device 200 may also include other suitable features and devices such as, for example, a camera, loud speaker, connectivity port, or tactile feedback features.

In one embodiment, the device 200, may be for example, a PDA style device 200′ illustrated in FIG. 2B. The PDA 200′ may have a keypad 110′, a touch screen display 220′ and a pointing device 250 for use on the touch screen display 220′. In still other alternate embodiments, the device may be a personal communicator, a tablet computer, a laptop or desktop computer, a television or television set-top box, or any other such device. The embodiments herein will be described with reference to the mobile communications device 200 for exemplary purposes only and it should be understood that the embodiments could be applied equally to any suitable device.

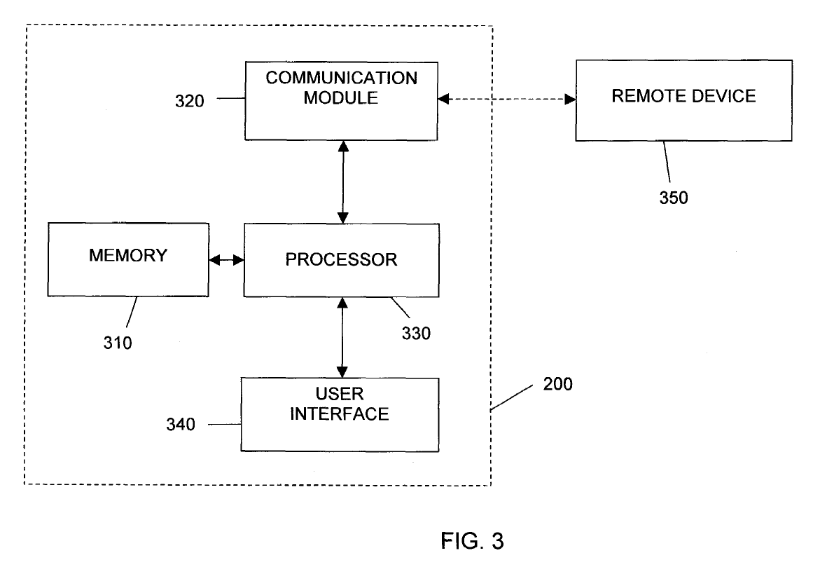

FIG. 3 is a block diagram illustrating various aspects of the communication device 200. The communication device 200 may have a processor 330 operable to execute programming, such as computer readable code for different device functions (e.g. email, calendar, IM, SMS, voice mail, etc). The processor may be communicably connected to a memory 310 for storing any type of suitable data (the computer readable code, the user's personal information, contact lists etc.), a user interface 340 for communicating with a user of the device 200, and a communication module 320. The user interface 340 may be substantially similar to the user interfaces described in the co-pending applications entitled “REPLYING THROUGH DIFFERENT CHANNELS”. Attorney Docket Number 684-012588-US (PAR) and “ACTIVE IDLE EXTENSION”. Attorney Docket Number 684-012589-US (PAR), the disclosures of which are incorporated herein in their entirety. The user interfaces may provide information to a user, in a single user interface for example, corresponding to one or more than one of the communication protocols and/or service providers. The communication module 320 may be adapted to communicate with any suitable remote device 350, such as a base transceiver, a server, a network, or any other suitable device. The communication module 320 may communicate with the remote device 350 using any suitable protocols, and may use any suitable medium, such as a wireless signal or wired link. For example, the communication module 320 may be adapted to communicate wirelessly with a remote base station using any suitable protocols (e.g. GPRS, GSM, CDMA). The communication module may be adapted to communicate using packet switched and/or circuit switched wireless communication, and may be adapted to operate simultaneously on different wireless channels.

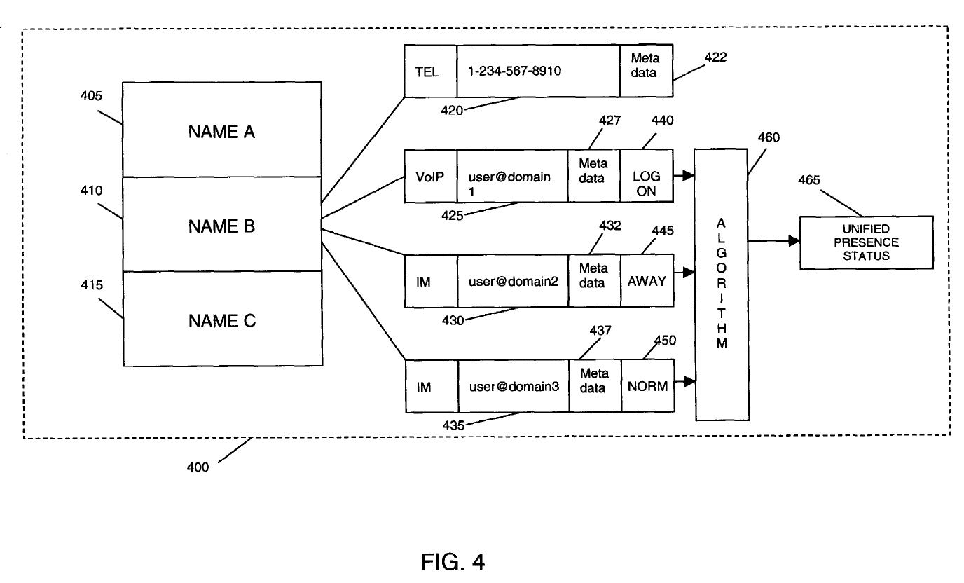

The device 200 may be configured to provide communications over multiple channels or protocols such as, for example, VoIP (voice over internet protocol), IM (instant messaging), cellular phone services, SMS (short message service), push to talk over cellular and the like. As illustrated schematically in FIG. 4, the communication device may have a contacts database. The contacts database may comprise, for example, data that is stored in the memory 310 and that is accessed, altered and maintained by the processor 330. In one embodiment, the database contains a collection of contact names and other contact information and data. Each of the contact names 405, 410, 415 in the collection of contact names 410 may be associated, in the database, with data indicating to the processor how communication may be initiated or maintained with a remote party identified by the contact name, as represented in FIG. 4 by blocks 420, 425, 430, and 435. The data may include information identifying one or more communication accounts or service providers through which the party may be accessible. For example, one account may be a telephone based account, another a VoIP account, and yet others may be IM accounts. The database may contain, for each account, information to be used in contacting the remote party. For example, in block 420 the telephone number is related to a phone service, and using the telephone number will enable a call to be placed through the respective service provider. For a VoIP (block 425) or IM account (blocks 430, 435), the identification of a particular service provider may be provided along with a username or screen name serving as an account identifier for a specific account of the party to be contacted. For some VoIP or IM accounts, there may be no specific service provider, or the service provider may not need to be identified. For example, an account identifier may be similar to a traditional email address of the form user@domain, may be an IP address, or may be any other suitable identifier.

The database may further contain information identifying a protocol to use in contacting the remote party using a particular account. For example, the database may identify an instant messaging protocol for use with an instant messaging account (e.g. Extensible Messaging and Presence Protocol (XMPP) or Session Initiation Protocol for Instant Messaging and Presence Leveraging Extensions (SIMPLE)). In one embodiment, the database may identify a software application to activate in the communication device, so that the software application may provide communication with the remote party using the appropriate protocol. The software application may be, for example, an IM or VoIP service provider client program (or both) for use with a specific IM and/or VoIP service provider. The client program may be adapted to operate on the communication device and to communicate with a remote server maintained by the service provider. In general, the contacts database may be used as a launchpad for other applications including any suitable communication application such as, for example, an email, IM, or VoIP application which may be issued by a service provider. The communication application may feature branding of the service provider or even branding and/or advertising of third parties which may be purchased by said third parties from the service provider. Such an application may be launched, for example, by selecting an icon from a contacts database user interface.

The contacts database 400 may contain presence information associated with one or more communication accounts. Presence information, as the term is used herein, generally identifies whether a party is accessible by, on-line with or connected to, a particular service provider. For example, in FIG. 4 the VoIP account of block 425 has presence information block 440. Similarly, each of the IM account blocks 430, 435 have respective presence information 445, 450. The presence information may, for example, be determined remotely by the party associated with the account. The presence information may convey whether or not the party is currently accessible using the account. For example, the presence information may comprise text statements indicating that the party is “free to chat”, “on-line” or “away”. In alternate embodiments, any suitable indication can be used to identify an availability or accessibility of a party, other than including text. In embodiment, each account can also include an additional metadata filed, illustrated as blocks 422, 427, 432 and 437. In alternate embodiments, each account can include fields for any suitable information, and which can be arranged in any particular or suitable order.

The presence information may, for example, indicate whether the party is available or not available, logged-in or logged-off, or on-line or off-line. The apparatus of the disclosed embodiments could include an indicator that provides the presence information. The presence information may allow for any number of possible indications. For example, the text statement “do not disturb” may indicate that the party is accessible through, for example, an IM account but that the party does not wish to be contacted at the present time. The presence information may be embodied as a text or graphical image or may be represented in any suitable format, such as a code, image, or audio clip. Presence information may be associated with a VoIP account, an IM account, or any other suitable account or accounts. Although presence information may be associated with a specific account, presence information for one account may also be relevant to another account. For example, if a presence status for one account indicates ‘do not disturb’, a user may choose to abstain from communicating with the contact through any other account, or through a conventional telephone call, because of this indication that the contact does not want to be disturbed. In one embodiment, the presence information could also provide information related to the availability of a user through one or more of the accounts with which the user is associated. In another embodiment, the presence information may not identify a specific account through which the user is able to be contacted or not contacted.

As may be seen in FIG. 4, a processor 460 may accept the several presence statuses 440, 445, 450 as inputs, to produce a unified presence status 465 as further described below. Each of the presence statuses may indicate the presence of a user on a communications account on a communications network.

The communications device may be adapted to monitor the presence status of one or more communication accounts. The presence status may be monitored, for example, by a service provider client program operating on the processor for each different service provider of a monitored account. A service provider client program may communicate with a server maintained by the service provider, to monitor the presence status. The client program may actively request notification of presence information, or may passively accept notifications of presence information that are initiated in response to an action of the remote party via the account (e.g. logging in, logging off), or may monitor presence information in any suitable way using any suitable protocol. Presence information may be monitored through peer-to-peer communication with a remotely operating client program operating the account, or through use of a distributed peer-to-peer network. Other embodiments may use any suitable program, protocol, or network to monitor the presence information.

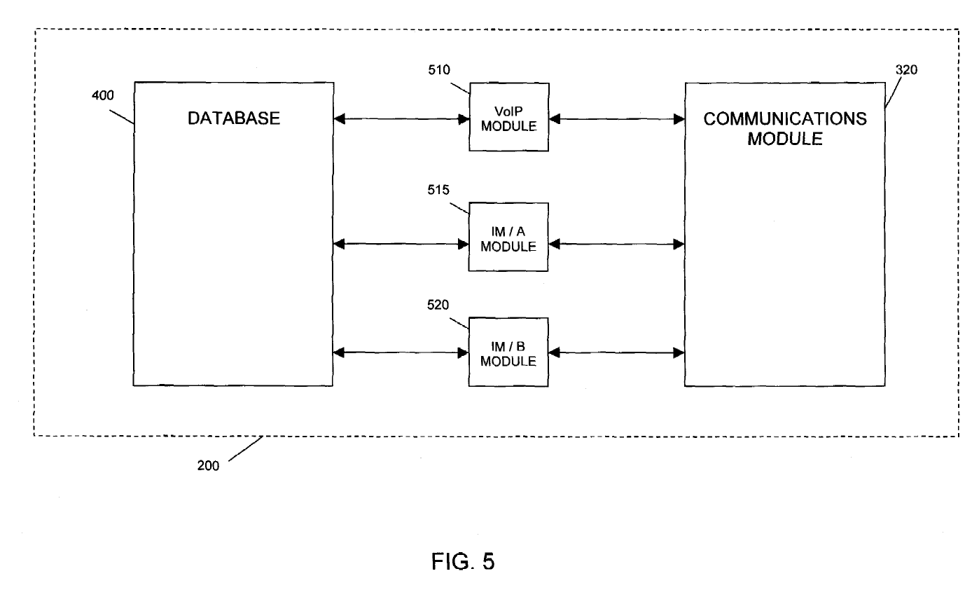

FIG. 5 shows, in one embodiment, an arrangement of modules incorporating aspects of the invention. Each of the modules may be embodied in hardware, software, or any other suitable form. In one embodiment, the contacts database may interact with various account interface modules 510, 515, and 520. Each account interface module may be adapted to communicate with one or more remote devices to obtain data representing a presence status (e.g. presence of a party on the account) for one or more account. The communication may employ the communication module 320, which may communicate with any suitable remote device 350 using any suitable protocol, as described above. In FIG. 5, VoIP module 510 may communicate with, for example, a remote server, to monitor a presence status associated with the VoIP account of block 425. Account interface module 515 may be a service provider client program for IM account A, represented in block 430, and may be adapted to monitor a presence status for that account. Account interface module 520 may be a service provider client program for IM account B, represented in block 435, and may be adapted to monitor a presence status for IM account B. Each of the modules 510, 515, and 520 may operate through the processor 330, and each may be communicably connected to both the database 400 and the communication module 320. Other embodiments may have any other suitable arrangement of modules, may be non-modular in design, or be of any other suitable form.

The database 400 may contain presence information for each account that has a monitored presence status. A contact name may be associated, in the database 400, with more than one such account. In FIG. 4, one contact name in block 410 is associated with four accounts, shown by blocks 420, 425, 430, and 435. In one embodiment, the processor 330 is configured to monitor each of the account presence statuses 440, 445, and 450, for each of the accounts associated with that contact name, and produce a unified presence status 465. The unified presence status 465 may also be stored in the database 400.

As shown in FIG. 4, one account associated with the contact name of block 410 may be associated with multiple accounts, represented by blocks 420, 425, 430, and 435. A telephone account, represented by block 420, is identified by a telephone number, and may not have a corresponding presence status that is monitored by the processor. Another account is a VoIP account, represented by block 425. The VoIP account may be a telephone account that operates using a communication protocol in which audio signals are transmitted in packet-switched form, using internet protocol. The VoIP account may be provided to the remote party by a service provider, and the service provider may communicate with a service provider client program 425 operating on the processor, so that the processor monitors a presence status of the VoIP account. The presence status of the VoIP account is represented by block 440. The contact name of block 410 may also be associated with two IM accounts A, B, represented by blocks 430 and 435. The processor may monitor the presence status of each of the IM accounts in the manner described above. The two IM accounts may be accounts that are provided by different service providers. The presence status of each account may be monitored by a different service provider client program 515, 520 operating on the processor 330, and the presence statuses may be registered in the contacts database, as represented by respective blocks 445, 450. In this example, there are four accounts through which a remote party may be contacted. The accounts are in different formats (e.g. telephonic, IM). The accounts may be accessed over different networks (e.g. telephone network, internet or other IP-based network) using different protocols (for example, one of the IM accounts may use an open-source protocol such as XMPP while the other uses a different, proprietary protocol).

In one embodiment, three of the accounts have an associated presence status, 440, 445, 450. The presence statuses may also be in different formats. For example, the presence status 440 for the VoIP account may allow for two states indicating that the remote party is logged on or, alternatively, not logged on. The presence status 445, 450 for each of the IM accounts A, B may have, for example, five possible states such as “normal”, “free to chat”, “away”, “extended absence”, and “do not disturb”. The presence status may be selectable by the remote party, using the corresponding account A or B. In other embodiments, the presence status may be user-defined. For example, the remote party may define a status with a short text string describing the status of the remote party. Thus, the remote party may convey, with the presence status, information beyond availability such as location of the remote party or what type of activity the remote party is currently engaged in. In one embodiment, the processing device 460 may accept the monitored presence status 440, 445, 450, for each account, and generate a uniform presence status 465 that is based on the underlying presence statuses for the several accounts.

In one embodiment, the processing device 460 may identify each presence status as indicating levels of availability. For example, each presence indicator may be assigned a rank, on an integer scale of 0-2. A rank of zero may indicate non-availability, while a rank of 2 may indicate positive availability. A rank of 1 may be assigned if the presence status does not correspond to either availability or non-availability (e.g. a presence status of ‘do not disturb’). For example, a presence status of ‘normal’ or ‘free to chat’ for one of the IM accounts may be assigned a rank 2. A status of ‘away’ or ‘extended absence’ may be assigned a rank 0, while a status of ‘do not disturb’ may receive a rank 1. The resulting uniform presence status 365 may then correspond to the highest rank for any communication account associated, in the database, with the contact name 410. Thus, if the party is available through any of the accounts, the uniform presence status may correspond to a rank of 2. Similarly, the uniform presence status may correspond to a rank of 1 if the highest availability is only partial or uncertain, and may correspond to 0 if none of the monitored presence statuses indicate availability. Mapping to a rank may facilitate the production of the unified presence status 365, because various accounts may have various ways of expressing the availability of a user, depending upon the protocol or format used. However, the rank mapping is merely an example, and other embodiments may produce the unified presence status without mapping each account presence status to a corresponding rank.

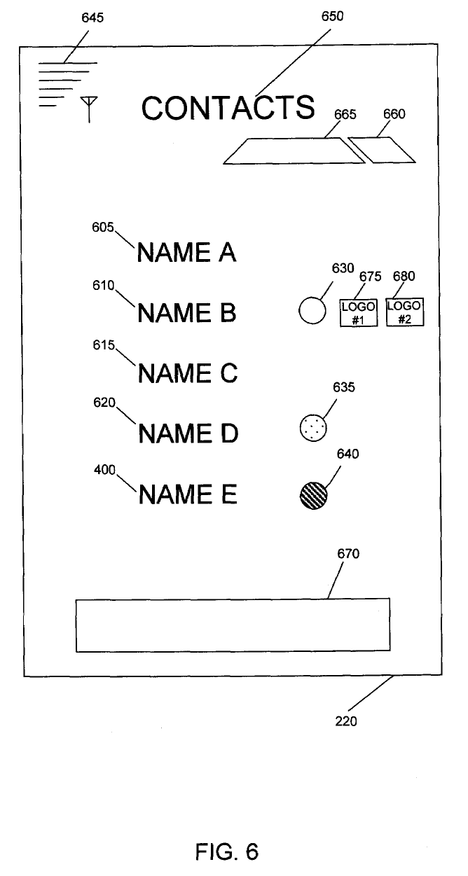

FIG. 6 illustrates one embodiment of a list of contact names on display 220. As shown in FIG. 6, at the top of the display appears a title 650 for the page. The page may have, for example, a signal strength indicator 645, selection buttons 665, 660, and a search window 670 by which to search for a contact name. A list of names may appear, for example in a middle portion of the display 220. In alternate embodiments, any suitable information can be displayed in any suitable arrangement or format.

In the example of FIG. 6, the list comprises five names 605, 610, 615, 620, 625. Each of the names may be selectable by the user, for example by scrolling to the desired name and pressing a key. One or more of the contact names may have a visual indication of a unified presence status for the associated contact name, appearing next to the corresponding contact name on the display. The visual indication may be, for example, one or several graphic icons. If there are more contact names than can be shown on the display simultaneously, the list of contact names may be prioritized such that, for example, only contacts having a presence status indicating availability are shown. In one embodiment, the visual indication may be a colored circle, with the color of the circle representing the unified presence status. A color of red may correspond to rank 0 (not available), green to rank 2 (available), and yellow to rank 1 (partial or uncertain availability, such as ‘do not disturb’). In the example of FIG. 6, an indicator 630 appears next to contact name 610 and may indicate a uniform presence status for contact name 610. Indicator 630 may, for example, appear green indicating that the remote party is available through one or more associated communication accounts. In the example of FIG. 6, display boxes 675, 680 may also be shown. Each display box 675, 680 may show a logo or other branding of a service provider that is providing an account of the contact for which a presence status indicates availability. In other embodiments, boxes 675, 680 may not appear. In still other embodiments, several colored circles (similar to indicator 630) or other indicators may appear next to the contact name 610, each indicating a presence status for an individual account associated in the database with the contact name 610. Returning to the example of FIG. 6, contact name 625 may have an indicator 640 that appears red, indicating the party is not available through any associated account. Contact name 615 may have an indicator 635 that is colored yellow indicating, for example, that the party may be reachable through one or more associated accounts but has requested not to be disturbed. Other contact names may have no icon appearing because, for example, only a traditional telephone number or other account not having presence information is associated with the contact name. By concurrently displaying multiple contact names along with multiple uniform presence status indicators for the various names, a user may be able to know which of the contacts are presently available for communication. The user may thus avoid initiating calls or messages that are not immediately answerable by the desired party. In other embodiments, any suitable device may be used to communicate the list of contact names and associated uniform presence statuses to the user. For example, the names may be audibly stated using a speaker and, following each name, a sound may be generated to indicate a corresponding presence status. The processor 330 may be programmed to accept a user selection of one of the contact names, and may initiate a communication session in response, using one of the associated accounts. The user may select the contact name, for example, by pressing one or more of the keys 230, 232, 233, 235, by speaking the name into the microphone, or in any other suitable way. The communication session may be, for example, a VoIP, mobile-to-mobile or traditional telephone call, an instant messaging session, or any other suitable communication session.

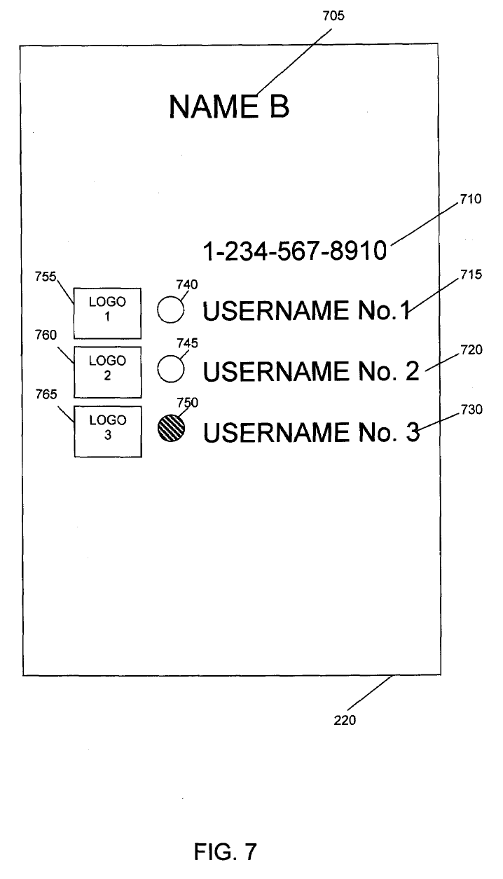

FIG. 7 illustrates an example of an account selection menu that may be displayed on the display screen 220 in response to a user selection of a contact name. A title 705 may appear on the top of the display 220, which indicates which contact names is selected. A username or account identifier may appear for each of the accounts. For example, block 710 may hold a telephone number for a telephone account. Block 715 may hold a username for a VoIP account, while, and blocks 720 and 730 may each hold usernames or screen names for two different IM accounts. Next to each username or account identifier 715, 720, 730 may be a respective icon 755, 760, 765. The icon may be, for example, a logo of the service provider of the communication account. The icon may further indicate the format or protocols used by the account, for example voice, IM, or any other suitable format. Also, next to each of the account identifiers 715, 720, 730 may be a respective presence status indicator 740, 745, 750, which indicates the monitored presence status associated with the respective account. The presence status indicators 740, 745, 750 may, for example, be of the green/yellow/red form described above with respect to the contacts menu page. In other embodiments, the presence status indicators may be of any suitable format. For example, each service provider may define their own format. In one embodiment, every account associated in the database with the selected contact name may be shown on the menu. Any of the accounts may be selected, for example a VoIP, IM, or email account, and communication may be initiated with the remote party regardless of whether or not the remote party is currently logged in to the specific account, or whether the presence status indicates availability. In one embodiment, an account may not appear on the menu if it has a monitored presence status indicating non-availability, as the remote party may not be presently contactable through that account. In one embodiment, the processor may accept a user selection of one of the accounts through which to initiate a communication, and the communication module may then initiate a communication session (e.g. phone call, IM session) with the remote party through the selected account. In one embodiment, the communication module may initiate a communication session through one of the accounts associated with a contact name in direct response to user selection of a contact name from a list of contact names, without providing an intermediary menu of accounts. For example, the account may be selected from among multiple accounts on the basis of user-defined criteria defined by the user prior to selection of the contact name. For example, the user may define a preferred service provider or a prioritization of service providers, with an account associated with the preferred (or highest priority) service provider being the account through which communication is initiated. An additional criterion may be that the account not have a monitored presence status indicating non-availability. The user-defined criteria may also be a prioritization of communication format or protocol. For example, the user may prefer to use IM for communication rather than telephone calls, and may configure the device to contact remote parties using IM, rather than a telephone call, when accounts operable with each format are both associated with the selected contact name in the database. Or, the user may prefer (e.g. for cost reasons) to communicate using the internet and to avoid using a mobile-to-mobile network or the traditional telephone (PTSN) system. The device may be adapted to accept a user preference for communicating using VoIP accounts associated with internet-based service providers over traditional wired or mobile telephone accounts. In another embodiment, the device may be operable to implement UMA technology that provides for seamless handover between a WLAN and base stations of the mobile telecommunications network 110. The user may define preferences to automatically change depending on whether the device 100 is currently communicating via WLAN or via the mobile network base station, as this may also affect how the communication is charged by the mobile service provider. For example, the user may give IM highest priority when connected to a mobile network base station to minimize cost, while giving voice calls highest priority when connected via WLAN. In other embodiments, the account may be chosen from among multiple accounts in any suitable way.

The contacts database may be used in additional functions of the device, for example a call logging function or a redial function. The database may maintain records of communications in various logs, such as a log of incoming calls/messages, log of missed calls/messages, and a log of outgoing calls/messages. Each of the logs may be viewable by the user on the display screen. As described above, multiple communication accounts may be associated in the database with a single contact name. Thus the multiple accounts may be integrated in a call/message log so that, for example, the contact name is displayed when viewing the log, while a specific account identifier may or may not be displayed. This may enable the user to quickly identify, for example, who placed an incoming call/message without concern for which account, service provider, or format was used. If the user desires to contact the party who placed the incoming call/message or from whom the incoming call/message was received, that party's contact name may be selected from the incoming call/message log. In response, the processor may determine, using the contacts database, through which account to communicate with the party. For example, an incoming call may have been made and received using VoIP account A, but the monitored presence status for that account at a subsequent point in time may indicate that the party is no longer available or is unavailable (e.g. not logged in or connected). The processor may automatically select another account through which the communication module may initiate a communication session. In one embodiment, the selected account is one that is indicated as being associated with that party. The other account may be of the same format and protocol (another VoIP account) for which presence data indicates availability, or may be another type of account (e.g. an IM account).

The contact database 400 may also be capable of importing and exporting contact data. Imported data may be integrated with existing data. For example, a user of mobile terminal 100 may also be a user of an IM service that is accessed through a different device such as a personal computer. In addition to contact database 400 maintained on the mobile terminal 100, another contact database associated with the IM service may be provided on the user's personal computer or other suitable device or location. A user may export contact data from the IM service contact database to the mobile terminal contact database 100. This data may be transmitted to terminal 100 using any suitable protocols or data conduits. For example, the data may be transmitted over the internet and sent to the phone using WiFi, may be sent over the mobile telecommunications network 110, may be transmitted directly from the personal computer or other device to the mobile terminal 100 using Bluetooth, or may be communicated in any other suitable way. The mobile device 100 may then integrate the received data into the existing contact database 400. For example, the device 100 may be enabled to allow the user to identify which, if any, of the imported data corresponds to existing contact names in the contact database 400. Thus, if the contact database holds a contact name and, for example, only a telephone number for that contact name, the user may be able to associate an imported IM, VoIP, email, or other account with the contact name in the contact database 400. In one embodiment, the mobile terminal 100 may be configured to automatically identify matching contact names between the existing data and the imported data, and to automatically add any new account for a matching contact into the database as associated with the existing contact name. The mobile terminal may further be configured to export data from the contact database in a similar manner.

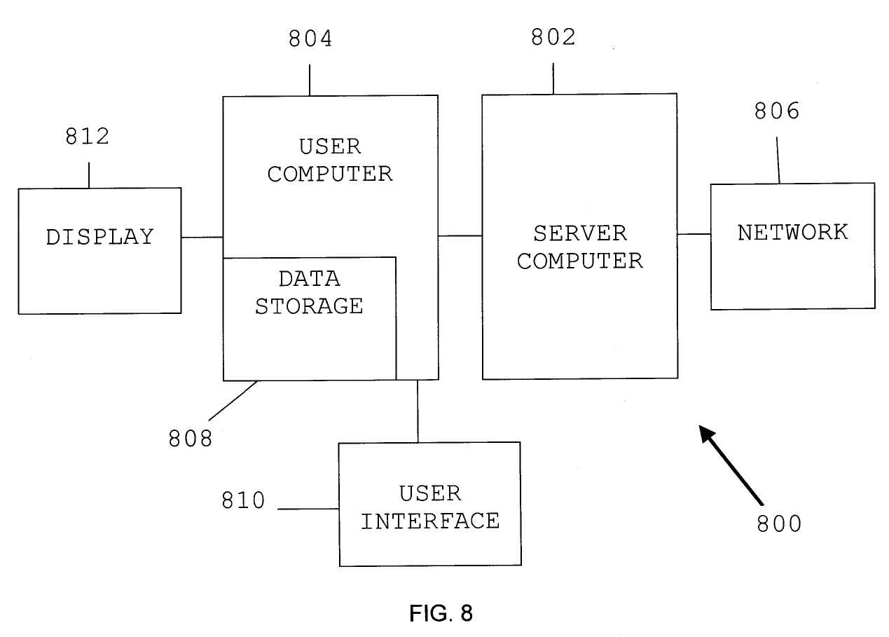

The disclosed embodiments may also include software and computer programs incorporating the process steps and instructions described above that are executed in different computers. FIG. 8 is a block diagram of one embodiment of a typical apparatus 800 incorporating features that may be used to practice the present invention. As shown, a computer system 802 may be linked to another computer system 804, such that the computers 802 and 804 are capable of sending information to each other and receiving information from each other. In one embodiment, computer system 802 could include a server computer adapted to communicate with a network 806. Computer systems 802 and 804 can be linked together in any conventional manner including, for example, a modem, hard wire connection, or fiber optic link. Generally, information can be made available to both computer systems 802 and 804 using a communication protocol typically sent over a communication channel or through a dial-up connection on ISDN line. Computers 802 and 804 are generally adapted to utilize program storage devices embodying machine readable program source code which is adapted to cause the computers 802 and 804 to perform the method steps of the present invention. The program storage devices incorporating features of the invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating features of the present invention may be stored in one or more computers 802 and 804 on an otherwise conventional program storage device. In one embodiment, computers 802 and 804 may include a user interface 810, and a display interface 812 from which features of the present invention can be accessed. The user interface 810 and the display interface 812 can be adapted to allow the input of queries and commands to the system, as well as present the results of the commands and queries.

The aspects of the disclosed embodiments allow for unifying different protocols/channels and other communication systems into a single user interface. An application programming interface is provided that allows each service provider to interface with the communications device disclosed herein. This allows for example, the combining of different contacts/user names into a single phone book, or contacts database. A contact name can then be associated with one or more user names for each service provider the contact name is associated with. The specific user name can be linked to a database of a specific service provider, based on the contact profile.

A presence system, based on a profile of the contact, can be used to provide a unified presence indication, which can appear in conjunction with the contact data. The presence indicator can then be used or accessed to identify a particular service provider to which the contact is connected or available on.

It should be understood that the foregoing description is only illustrative of the disclosed embodiments. Various alternatives and modifications can be devised by those skilled in the art without departing from the disclosed embodiments. Accordingly, the disclosed embodiments are intended to embrace all such alternatives, modifications and variances which fall within the scope of the appended claims.

What is claimed is:

1. An apparatus comprising:
a controller;
a memory connected to the controller;
a user interface connected to the controller; and
a communication module connected to the controller;
wherein the controller is configured to store, in the memory, a set of contact names, each contact name being associated with one or more account identifiers that identifies a communication protocol for communicating with the contact;
wherein the controller is further configured to establish a communication connection to a selected contact via a communication protocol associated with a selected account identifier.

2. The apparatus of claim 1, wherein the controller is configured to monitor an account availability status for each of the communication accounts.

3. The apparatus of claim 2, wherein the controller is configured to provide an indicator responsive to any of the monitored account availability statuses.

4. The apparatus of claim 3 wherein the indicator is responsive to more than one of the monitored account availability statuses.

5. The apparatus of claim 4, wherein the indicator does not identify which of the accounts a contact is available through.

6. The apparatus of claim 5, wherein the controller is further configured to present to the user, in response to a user selection of a contact name, a menu of only those account identifiers associated with the contact name that have a monitored account availability status indicating that the contact is available.

7. The apparatus of claim 4 wherein the controller is configured to respond to user selection of a contact name by automatically selecting an account identifier associated with the selected contact name and having an availability status that indicates the contact is available, and wherein the controller is further configured to automatically establish communication with the contact through the selected account.

8. The apparatus of claim 1, wherein the apparatus is a mobile telephone.

9. A method comprising:
storing, in a memory of a communications device, at least a list of contact names and a set of account identifiers for each name, each account identifier being associated with a different service provider; and
monitoring a presence for a contact name for each of the more than one account identifiers on a communications network.

10. The method of claim 9 wherein each account identifier is associated in the memory with a different communications protocol.

11. The method of claim 9, further comprising:
selecting a contact from the set of contacts;
selecting a communication protocol associated with the selected contact; and
establishing a communication connection to the selected contact using the communication protocol.

12. The method of claim 11 wherein a communication protocol of the user is different from the communication protocol associated with the selected contact.

13. The method of claim 11 further comprising selecting a username from a list of user names associated with the selected contact, wherein the selected username is associated with a specific communication protocol and the communication connection is automatically established over the specific communication protocol.

14. The method of claim 9 further comprising:
selecting a contact from the set of contact names;
selecting an account from a set of account identifiers associated with the contact name and having a monitored presence indicating that the contact is present; and
establishing communication with the contact through the selected account.

15. The method of claim 14 wherein selecting an account from a set of account identifiers comprises selecting an account based on cost criteria.

16. The method of claim 9 further comprising responding to a user selection of a contact name by automatically establishing communication with the selected contact name through an account for which a monitored presence indicates that the contact is present on a communications network.

17. A computer program product comprising:
a computer useable medium having computer readable code means embodied therein for causing a computer to maintain a list of contact names in a computer memory, at least one of the contact names being associated, in the memory, with more than one account identifier.

18. The computer program product of claim 17, further comprising computer readable code means for causing a computer to monitor, through at least one communications network, a presence for a contact for each account identifier associated with the contact.

19. The computer program product of claim 18, further comprising computer readable code means for causing a computer to produce an indication expressing to a user the presence of the contact through any monitored account, without the indication expressing any specific account through which the contact is present.

20. The computer program product of claim 19, further comprising computer readable code means for causing a computer to display the contact name of the contact, and the indication, in a menu of contact names.

21. The computer program product of claim 20, further comprising:
computer readable code means for causing a computer to respond to a user selection of a contact name from the menu of contact names by displaying a menu of account identifiers associated with the selected contact name; and
computer readable code means for causing a computer to establish communication with the selected contact name through the account identified by a selected account identifier.

22. A user interface comprising:
means for displaying a contact;
means for displaying at least one contact field associated with the contact, the at least one contact field including information associating the contact with a respective communication service provider;
means for displaying information related to an availability of the contact over one of the respective communication service providers; and
means for selecting one of the at least one contact fields to initiate a communication with the contact.
